(19) United States
(12) Patent Application Publication
(10) Pub. No.: US 2022/0212303 A1
(43) Pub. Date: Jul. 7, 2022

(54) MACHINING METHOD

(71) Applicant: HOMAG GmbH, Schopfloch (DE)

(72) Inventors: Rolf HOFBAUER, Gaeufelden (DE); Markus MORLOCK, Freudenstadt (DE); Ruven WEISS, Alpirsbach (DE); Philipp SEKINGER, Aichhalden (DE)

(21) Appl. No.: 17/604,361

(22) PCT Filed: Apr. 16, 2020
(86) PCT No.: PCT/EP2020/060698

§ 371 Date: Oct. 15, 2021

(30) Foreign Application Priority Data
Apr. 17, 2019 (DE) 10 2019 110 137.9

(51) Int. Cl. B23Q 15/12; G05B 19/40; G05B 19/404

(52) U.S. Cl. CPC B23Q 15/12; G05B 19/40; G05B 2219/45229; G05B 2219/37435; G05B 19/404

(57) ABSTRACT

A machining method for machining workpieces preferably consisting at least in sections of wood, wood materials, plastic or the like on a machining device, wherein a vibration state of the machining device is detected during a machining process, a closed-loop or open-loop control towards a lower or preferably optimal vibration state of the machining device is performed while the machining process is continued.

### TECHNICAL FIELD

The present invention relates to a machining method, wherein the workpiece is preferably formed at least in sections of wood, wood materials, plastic or the like, according to the preamble of patent claim 1.

### PRIOR ART

The applicant is aware of machining methods on workpieces preferably consisting at least in sections of wood, wood materials, plastic or the like, in which vibration states occur on machining devices used. Particularly strong vibration states result in the quality of the machining result suffering, noise emission occurring and the mechanical load of the machining devices being increased.

A known solution thereto is the reconstruction of machining devices. By means, for example, of the targeted stiffening of individual components thereof, natural frequencies of the machining devices can be increased; this can be simulated using modal analyses.

However, this known solution has the disadvantage that for this purpose, major constructive adjustments must be made to (existing) machining devices. Furthermore, stiffening individual components usually has the effect that these components also have a higher weight, which requires the use of more material and more installation space.

Thus, this solution is subject to tight limits which may be imposed by, inter alia, the installation space, permissible maximum weight or the production costs of the machining devices.

### DESCRIPTION OF THE INVENTION

It is therefore the object of the present invention to provide a machining method in which the vibration states can be reduced, without this causing disadvantages such as higher weight, more material use and more installation space of the machining devices.

According to the invention, this object is solved by a machining method according to claim 1. Particularly preferred further developments of the invention are specified in the dependent claims.

The invention is based on the idea that strong vibration states occur in particular at certain machining speeds which correspond to the natural frequencies of the machining devices. Furthermore, it was recognized that by adjusting the machining speeds, it is possible to depart from these natural frequencies of the machining devices. It was recognized that for this purpose, a detection of vibration states during operation can be utilized in order to achieve a closed-loop or open-loop control towards a lower or preferably optimal vibration state of the machining device while the machining process is continued. Moreover, by continuing the machining process, a short pass-through time is achieved.

According to the invention, therefore, a machining method is provided for machining workpieces preferably consisting at least in sections of wood, wood materials, plastic or the like on a machining device, wherein a vibration state of the machining device is detected during a machining process, and a closed-loop or open-loop control towards a lower or preferably optimal vibration state of the machining device is performed while the machining process is continued.

Numerous advantages can be made possible by a machining method according to the invention. For instance, vibration and noise emission is optimized owing to the optimized operation range. Process reliability can also be increased by detecting wrong process parameters, e.g. with abnormal vibration states. This also enables a reduction in maintenance costs by early recognition of component faults and comes along with a considerable increase in service life and availability of the machine and a check of the tool clamping for example by unbalance. Furthermore, the detection of wear and special events such as force and voltage peaks can also be achieved. All this increases the service life of machining devices, and increases their machining quality.

Preferably, closed-loop or open-loop control towards a lower or preferably optimal vibration state of the machining device is performed by adjusting a machining speed of the machining process.

The machining speed of the machining process is achieved, for example, by means of electric motors that can be controlled accordingly. It should be noted here that a rotational frequency of the electric motors corresponds to the frequency of the vibration state of the machining device. In particular the speed of electric motors can be adjusted in an uncomplicated and accurate manner.

It is also preferred that the vibration state of the machining device is detected by a force sensor and/or strain gauge and/or vibration sensor and/or laser sensor and/or acoustic sensor and/or structure-borne sound sensor and/or piezoelement, wherein the vibration sensor is preferably an acceleration sensor, velocity sensor or displacement sensor.

These measuring devices have become established for measuring vibration states.

Even more preferably, a connection between a machining speed of the machining process and the vibration state of the machining device is carried out by means of an initial measurement during idling.

This can make it possible to establish a functional connection between speed and vibration state, i.e. to correlate vibration minima and vibration maxima with different speeds.

Here, the initial measurement during idling can be a speed sweep at which occurring vibrations are detected at predetermined, varying speeds.

Thus, all relevant speeds can be systematically detected, and vibration states can be attributed to these speeds.

With the machining method, acquired data from the operation and/or from the initial measurement can moreover be provided to a database or an IoT (Internet of Things) platform and, preferably, the closed-loop or open-loop control can be adjusted by data of the database or the IoT platform.

By collecting data in a database or an IoT platform, predictions as to the service life can be made using many data sets, thus e.g. achieving precautionary maintenance based on measurement data, statistical models and IoT algorithms. This corresponds to a cloud functionality.

Even more preferably, the machining process is continued during the closed-loop or open-loop control in that the relative movement between the machining device and the workpiece is not interrupted.

This means shorter machining times per workpiece, which increases productivity.

The machining process is preferably a milling process and/or a drilling process. These machining processes make it possible to adjust vibration states during performance thereof quickly and in an uncomplicated manner, e.g. by adjusting the drive speed.

In a further representation of the present invention, the machining method is performed on a plurality of machining devices which are controlled by closed-loop or open-loop control towards their own vibration state that is different from the others.

By decoupling different machining devices, increased excitation due to positional couplings of the unbalances of the machining motors can be prevented.

### BRIEF DESCRIPTION OF THE DRAWINGS

FIG. 1 shows a view of a machining device of a first embodiment of the present invention.

FIG. 2 shows a flow chart of a first embodiment of the present invention.

FIG. 3 shows an actual state and a target state of a vibration state of a first embodiment of the present invention.

### DETAILED DESCRIPTION OF PREFERRED EMBODIMENTS

In the following, preferred embodiments of the present invention will be described with reference to the enclosed drawings. The embodiments described below can be combined in full or in part to form further embodiments.

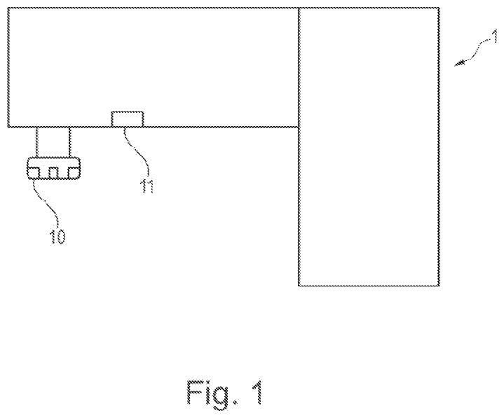

FIG. 1 shows a view of a machining device of a first embodiment of the present invention.

In particular, FIG. 1 shows a machining device 1 which can perform machining methods according to the invention on workpieces preferably consisting at least in sections of wood, wood materials, plastic or the like.

This is enabled in the machining device 1 by a milling head 10 that can perform machining processes, by means of rotating movements, on workpieces that preferably consist at least in sections of wood, wood materials, plastic or the like.

Furthermore, the machining device 1 has a sensor 11 that is configured to measure vibrations during a machining process. The exact position of the sensor 11 is particularly advantageous where a particular stretching/compression of the corresponding part of the machining device 1 takes place. This can be measured and/or simulated by means of modal analyses and/or determined by trial and error.

The sensor 11 forwards the acquired data to a control device that is not shown. The control device is able to analyze the collected data and to send a control signal to the milling head 10 on the basis thereof. Based on this control signal, the milling head 10 can then adjust its milling speed.

The control device of the preferred first embodiment shown here also comprises a communication module using which the collected data can be transferred to a database or an IoT (Internet of Things) platform. The communication module is preferably provided as a network module or WLAN module. Furthermore, the communication module can also receive data from the database or the IoT platform in order to thus adjust an existing control.

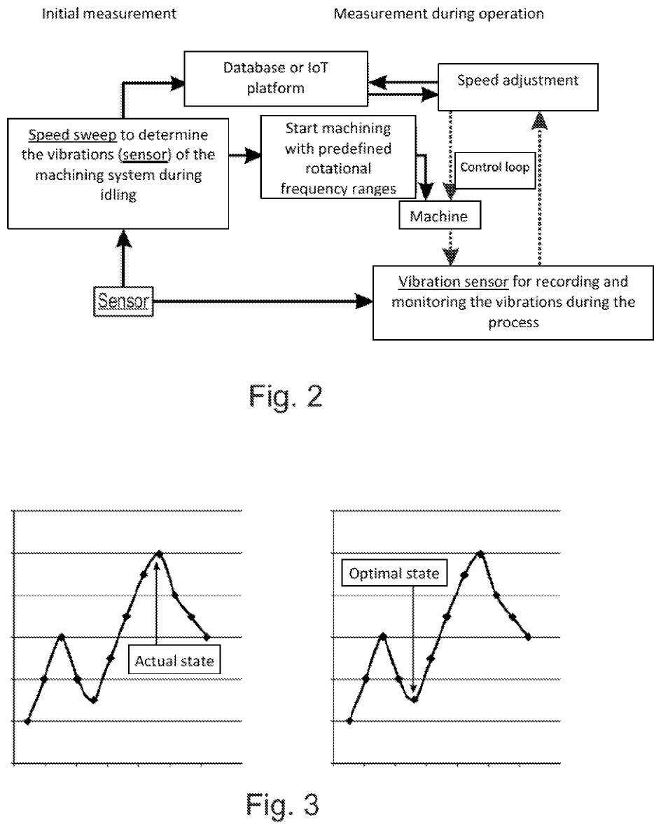

FIG. 2 shows a flow chart of a first embodiment of the present invention.

In the left-hand area, an initial measurement is shown. This initial measurement can be carried out periodically, e.g. daily or weekly, and can serve as a calibration. Furthermore, it may also be necessary to design a new closed-loop control, for example for the use of a new milling head, for which the initial measurement is also performed.

In the initial measurement, a sensor provides data during a speed sweep. Here, speeds are given to the milling head 10, for example, with increasing speed, and resulting vibrations of the sensor 11 are detected. Thus, a functional connection between speed and vibration intensity can be established.

The data acquired in this manner can be provided to the database or the IoT platform.

In the right-hand area, a measurement during operation is shown.

Here, the machining device 1 starts the machining at a predetermined rotational frequency in a predetermined rotational frequency range. The operation at this rotational frequency causes vibrations that are detected by the sensor 11. Based on the vibrations with a certain rotational frequency, the control device now adjusts the rotational frequency within the predefined rotational frequency range in order to thus minimize or at least reduce the vibrations.

This process is therefore a control loop in which an actual value is controlled towards a target value. For example, a PID controller composed of a proportional, an integral and a derivative controller can be used as a controller.

Other controllers are also conceivable, of course; it is generally preferred that individual control parameters can be further optimized during operation.

FIG. 3 shows a diagram with an actual state and a target state of a vibration state of a first embodiment of the present invention.

In both diagrams, the course of the vibration intensity of an increasing speed is plotted. This curve can be detected by means of a speed sweep in the context of an initial measurement as shown above, for example. One measure of the vibration intensity is the vibration amplitude, for example.

At an actual speed, which is shown in diagram I, comparatively high vibration intensities occur. By the closed-loop control according to the invention, control towards a target speed in diagram II can be achieved, which constitutes a local minimum. A rotational frequency range can be specified in which the machining process takes place. For milling processes in the (CNC) stationary operation on workpieces consisting at least in sections of wood, wood materials, plastic or the like, a rotational frequency of, e.g., 24000 rpm is considered optimal, wherein this can be varied, for example, in a rotational frequency range of 10000 rpm to 30000 rpm, preferably 20000 rpm to 28000 rpm and more preferably 22000 rpm to 25000 rpm. For milling processes in continuous operation on workpieces consisting at least in sections of wood, wood materials, plastic or the like, a rotational frequency of, e.g., 6000 rpm is considered optimal, wherein this can be varied, for example, in a rotational frequency range of 4000 rpm to 30000 rpm, preferably 5000 rpm to 12000 rpm and more preferably 5000 rpm to 7000 rpm. Within these ranges, an optimum can be identified by means of a speed sweep, which serves as the new target value.

A second embodiment of the present invention comprises a machining device carrying out a machining process of cutting and/or edgebanding. With both possible machining processes, vibrations may occur that are minimized by means of the present invention. Cutting can be performed by means of a cross-cut saw blade whose speed is varied, and when performing edgebanding, the rotation of a pressure roller and/or the movement of mechanical components of a gluing device can be varied.

In a third embodiment, which is not shown, the machining method has a plurality of machining devices, e.g. corresponding to the first or second embodiment. These different machining devices are controlled by open-loop or closed-loop control with different target rotational frequency ranges such that each machining device works in a rotational frequency occurring only once. This results in that increased excitation owing to positional couplings of the unbalances of the machining motors is prevented.

### LIST OF REFERENCE NUMBERS

1 Machining device
10 Milling head
11 Sensor

1. Machining method for machining workpieces preferably consisting at least in sections of wood, wood materials, plastic or the like on a machining device, wherein
a vibration state of the machining device is detected during a machining process, and a closed-loop or open-loop control towards a lower or preferably optimal vibration state of the machining device is performed while the machining process is continued.

2. Machining method according to claim 1, wherein
the closed-loop or open-loop control towards a lower or preferably optimal vibration state of the machining device is performed by adjusting a machining speed of the machining process.

3. Machining method according to claim 1, wherein
the vibration state of the machining device is detected by a force sensor and/or strain gauge and/or vibration sensor and/or laser sensor and/or acoustic sensor and/or structure-borne sound sensor and/or piezoelement, wherein the vibration sensor is preferably an acceleration sensor, velocity sensor or displacement sensor.

4. Machining method according to claim 1, wherein
a connection between a machining speed of the machining process and the vibration state of the machining device is carried out by means of an initial measurement during idling.

5. Machining method according to claim 4, wherein
the initial measurement during idling is a speed sweep at which occurring vibrations are detected at predetermined, varying speeds.

6. Machining method according to claim 1, wherein
acquired data from the operation and/or from the initial measurement can be provided to a database or an IoT (Internet of Things) platform and, preferably, the closed-loop or open-loop control is adjusted by data of the database or the IoT platform.

7. Machining method according to claim 1, wherein
the machining process is continued during the closed-loop or open-loop control in that the relative movement between the machining device and the workpiece is not interrupted.

8. Machining method according to claim 1, wherein
the machining process is a milling process and/or a drilling process.

9. Machining method according to claim 1, wherein
the machining method is performed on a plurality of machining devices which are controlled by closed-loop or open-loop control towards their own vibration state that is different from the others.
